(19) United States
(12) Patent Application Publication
(10) Pub. No.: US 2026/0327139 A1
(43) Pub. Date: Oct. 22, 2026

(54) Refractory Composition

(71) Applicant: Henkel AG & Co. KGaA, Duesseldorf (DE)

(72) Inventors: John Macharia, Ashford, CT (US); Zachary Bauman, Mountain View, CA (US); James Murray, Newmarket, NH (US); Donna Marie Mamangun, Rocky Hill, CT (US)

(21) Appl. No.: 19/468,016

(22) Filed: Feb. 3, 2026

Related U.S. Application Data
(63) Continuation of application No. PCT/US2024/040895, filed on Aug. 5, 2024.
(60) Provisional application No. 63/519,301, filed on Aug. 14, 2023.

(51) Int. Cl. C04B 28/06; C04B 14/04; C04B 24/26; C04B 111/00

(52) U.S. Cl. CPC C04B 28/06; C04B 14/046; C04B 24/26; C04B 2111/00431

(57) ABSTRACT

A refractory composition includes a blend of alumina and silica, wherein the alumina is provided with a heterogeneous particle shape distribution among a plurality of alumina species. One alumina species includes particles with a convex outer surface within a substantially monodisperse particle size distribution. The alumina of the refractory composition is further provided with a multimodal particle size distribution.

### FIELD OF THE INVENTION

The present invention relates to refractory compositions generally, and more particularly castable refractory compositions that facilitate the production of durable cast articles that are useful in corrosive and abrasive environments. The cast articles may be particularly useful in the iron smelting industry for conveying molten steel.

### BACKGROUND OF THE INVENTION

Refractories are materials having properties that make them suitable for use as heat-resistant barriers or conveyors in high temperature applications. Refractories may also be referred to as refractory cements, which may be castable into liners or free-standing guides or containers for the handling of high temperature materials such as liquid metals and slags.

Steel recycling has become an increasingly important supply source for steel throughout the world. Scrap metal is processed in recycling plants by melting the incoming scrap steel at temperatures exceeding 1000-1600° C. in electric arc furnaces. The molten steel is poured on refractory cement guides known as runners to direct the molten steel into different molds for casting. The pour time is typically about 5-10 minutes, followed by a 20-30 minute interval of heating. The steep heat gradient of pouring and cooling introduces thermal shock to the refractory runner. In addition, molten steel is highly corrosive and abrasive. Such conditions introduce significant wear and tear on the runner, which limits typical useful lifetimes to about 7-10 days. To extend runner lifetimes, patching procedures may be performed. However, patching requires process downtime, when most recycling plants are expected to operate continuously.

Current refractory runners are designed for low thermal expansion, low thermal conductivity, high strength, and high abrasion and corrosion resistance at high temperatures. High alumina cement has been used with different amounts of silica, magnesium oxide, and zirconia in attempts to achieve these properties. Typically, steel wires are used as reinforcement to structurally support conventional refractories used in high temperature, highly corrosive and abrasive environments. However, conventional refractory composites have alumina:silica ratios that lead to insufficient abrasion and corrosion resistance, and/or resistance to thermal expansion. Moreover, aggregates such as cristobalite, alumina, and silica are added to reinforce the cast structure in conventional refractory cement materials. Upon corrosion of the cast structure, these irregularly-shaped aggregates are exposed to the surface and impede molten steel flow as a result of increased friction.

It is therefore an aspect of the invention to provide a castable refractory material that exhibits high durability in aggressive environments, wherein the cast bodies exhibit good abrasion and corrosion resistance in high temperature and temperature-cycling environments, as well as excellent thermal-mechanical strength.

It is another aspect of the invention to provide a refractory material that exhibits reduced frictional resistance to fluid flow across its surface. The reduced frictional resistance exerted by the refractory material, even when corroded, reduces abrasive and corrosive damage to the material, and therefore reduces operational downtime for repair and replacement.

### SUMMARY OF THE INVENTION

By means of the present invention, refractory materials may be provided in various forms for durable exposure to harsh environments, including high temperatures, rapid temperature cycling, corrosiveness, and abrasiveness. The materials may be cast into refractory cement guides that are capable of durably handling high temperature liquids, such as molten metals, with relatively low susceptibility to corrosion and abrasion. The guides also exhibit reduced frictional resistance to fluid flow, such as the high temperature liquids, with a smoother aggregate shape.

In one embodiment, a composition for forming a refractory cement includes 65-85 wt. % alumina particles having a heterogeneous particle shape distribution, including a first particulate alumina of particles with a convex outer surface shape and a median particle size (d₅₀) of between 0.1 and 5 mm. The first particulate alumina comprises between 25-50 wt. % of the total alumina particles in the composition. A second particulate alumina of particles has an irregular outer surface shape. The composition further includes between 5-25 wt. % of silica.

In some embodiments, the composition may include up to 10 wt. % of a zirconium component optionally including zirconium silicate. The composition may include 5-20 wt. % water and between 1-5 wt. % zirconium silicate. The composition may include a first part that is mixable with a second part to form the refractory cement, wherein the first part includes the alumina particles, and the second part includes the water.

In some embodiments, the alumina particles include an α-alumina component and a ρ-alumina component, the α-alumina component including the first particulate alumina. In some embodiments, the ρ-alumina component has a mean particle size (d₅₀) of between 1 and 100 μm and comprises between 10-25 wt. % of the total alumina particles. In some embodiments, the α-alumina component includes the second particulate alumina having a mean particle size (d₅₀) of between 0.1 and 5 μm, and a third particulate alumina having a mean particle size (d₅₀) of between 0.01 and 0.5 mm.

In some embodiments, the first alumina particles are substantially spherical, having an aspect ratio of between 0.8 and 1.2. The composition may include a dispersing agent including polycarboxylic acid.

In another embodiment, a refractory cement includes 65-85 wt. % alumina, 10-20 wt. % silica, and 1-5 wt. % zirconium oxide, wherein an aggregate portion of the refractory cement includes substantially spherical α-alumina particles having an aspect ratio of between 0.8 and 1.2 and a median particle size (d₅₀) of between 0.1 and 2.5 mm. The aggregate portion of the composition may be between 25-45 wt. % of the refractory cement.

In some embodiments, the substantially spherical α-alumina particles are substantially monodisperse in particle size, having a d₉₀ dimension of less than 5 mm.

An article may be formed from the refractory cement. In some embodiments, the article may be configured for conveying molten material. The article may include a channel with a base portion between first and second upstanding walls.

A method for producing a refractory cement includes forming a first part of a composition, wherein the first part includes 65-85 wt. % alumina particles having an α-alumina component and a ρ-alumina component. The α-alumina component may include a heterogeneous particle shape distribution including a first particulate alumina of substantially spherical particles having a mean particle size (d₅₀) of between 0.1 and 5 mm. The method may further include forming a second part of the composition including water, wherein at least one of the first and second parts include zirconium silicate and silica. The zirconium silicate may be present in an amount of between 1 and 5 wt. % of the composition. The silica may be present in an amount of between 5 and 25 wt. % of the composition. The first and second parts are mixed, and the mixture may be cured by exposing the mixture to a temperature of at least 1000° C. for a time period sufficient to cure the mixture to the refractory cement.

In some embodiments, the α-alumina component of the first part may include a second particulate alumina of particles having a mean particle size (d₅₀) of between 0.01 and 0.5 mm, and a third particulate alumina of particles having a mean particle size (d₅₀) of between 0.1 and 5 μm. The particles of the second and third particulate alumina may be irregular in shape.

In some embodiments, the ρ-alumina component has a mean particle size (d₅₀) of between 1 and 100 μm.

In some embodiments, the composition includes a dispersing agent comprising a polycarboxylic acid.

In some embodiments, the silica is particulate in form with a mean particle size (d₅₀) of less than 20 nm.

### BRIEF DESCRIPTION OF THE DRAWINGS

FIG. 1 is an illustration of an example article formed from the refractory materials of the present invention.

FIG. 2 is a flow diagram of a method for forming an article from the refractory materials of the present invention.

FIG. 3 is a chart illustrating mass retention of samples undergoing abrasion testing with thermal cycling.

FIG. 4 is an enlarged view of a portion of the chart of FIG. 3.

### DETAILED DESCRIPTION OF THE INVENTION

The objects and advantages enumerated above together with other objects, features, and advances represented by the present invention are now described in terms of detailed embodiments. Other embodiments and aspects of the invention, however, are recognized as being within the grasp of those having ordinary skill in the art. Specifically, the features described with respect to the present compositions and apparatus may be combined in ways other than that described in the claims, as well as in ways other than that described in the specification.

A composition, such as for forming a refractory material, is provided. For the purposes hereof, the refractory material may be referred to as a refractory cement. However, the refractory materials described herein are referred to as a “cement” merely in that they may exhibit cementitious behaviors like forming a plastic, curable paste when mixed with water. The refractory materials described herein need not include lime, iron oxide, magnesia, or other materials commonly associated with cement. The refractory materials described herein may, however, include such materials in trace or non-trace concentrations.

The compositions described herein primarily include alumina (Al₂O₃) and silica (SiO₂), as well as aluminosilicates, which are sometimes referred to as “mullite”. Typical aluminosilicates are characterized by 3Al₂O₃2SiO₂ or 2Al₂O₃SiO₂. The compositions may include combinations of alumina, silica, and aluminosilicates. The compositions may further include a zirconium component, water, dispersing agents, and other materials, either as significant ingredients or impurities.

The present compositions may be formed from two parts into a mixture or slurry and cast into a mold for curing or firing. In some embodiments, the compositions are considered to be “castable” by being formable into a joint-less or unshaped product upon addition of water, then setting and drying (curing) to remove excess water. Curing or “firing” of the castable compositions is typically accomplished by the application of heat, as will be described in greater detail below.

### Alumina

In embodiments of the present invention, compositions for forming a refractory cement include between 65-85 wt. % alumina. In some embodiments, compositions for forming a refractory cement include between 70-80 wt. % alumina. In some embodiments, the amount of alumina in the compositions may be defined by a ratio of alumina:silica. In some embodiments, the ratio (w:w) of alumina:silica may be between 65-90:10-30. In some embodiments, the ratio (w:w) of alumina:silica may be between 70-85:15-30. In some embodiments, the ratio (w:w) of alumina:silica may be between 75-85:15-25. The wt. % ranges of alumina and the ratios of alumina:silica described herein have been found to be important to the crystal phase of the mullite formed between the alumina and silica in the compositions. The crystal phase developed defines important physical properties of the refractory cement, such as abrasion resistance and corrosion resistance. It is therefore to be understood that concentrations of alumina or other components of the present compositions outside of the recited ranges may not result in desired final products.

The alumina utilized in compositions of the present invention may preferably be in particulate form. Applicant has found that certain heterogeneous mixtures of alumina particles provide surprising benefits in the crystal phase structure of the refractory cement, to yield surprisingly beneficial physical properties like enhanced abrasion resistance, corrosion resistance, thermal cycle durability, and cold crush strength. The heterogeneity of the alumina particles may be in one or both of particle size and shape. Preferably, the alumina particles used in the present compositions exhibit heterogeneity in both particle size and shape. However, the heterogeneity may in some embodiments be limited to the presence of different groups of alumina particles, wherein one or more groups of alumina particles may exhibit monodispersity in one or both of particle size and shape. For the purposes hereof, the term “monodisperse” or “monodispersity” is intended to mean a similarity in particle size and/or particle shape among particles within a defined group or class of particles. The similarity may be recognized by a small range between a median particle size (d₅₀) and a d₉₀ particle size dimension, or a small aspect ratio range. A monodisperse group of particles is one in which the particles are intentionally similar in size and/or shape.

The alumina particles of the refractory cement-forming compositions of the present invention preferably include a first particulate alumina species of particles. The first particulate alumina “species” refers to a type or class of alumina particles and may be referred to herein as the first particulate alumina. The particles of the first particulate alumina may have a convex outer surface shape. For the purposes hereof, the term “convex” is intended to mean “having a curved form which bulges outward, resembling the exterior of a sphere or cylinder or section of those bodies”. Applicants have discovered that, by using convex alumina particles, at least as a portion of the total amount of alumina particles in the refractory compositions, enhanced physical properties of the refractory cement may be realized. In particular, the smooth, curved surfaces of the convex alumina particles present a substantially smoother contact surface between the refractory cement body and the fluid being handled by such refractory cement body. Frictional resistance to fluid flow across the contact surface is therefore significantly reduced, which correspondingly reduces corrosion effects caused by turbulent flow action around and adjacent to points of flow resistance.

In some embodiments, the convex first alumina particles may be employed at least in part as an aggregate material in the refractory cement. Aggregates are granular materials that are used with a cement structure to increase the mechanical strength of the formed structure. As the structure is abraded over time with use in an abrasive and/or corrosive environment, the aggregate becomes increasingly exposed. Conventional refractory materials often use alumina and other minerals having sharp edges and corners that increase frictional resistance to fluid flow at the contact surface. By contrast, the convex first alumina particles of the present aggregate provide smooth, low friction surfaces, which prolongs the useful lifetime of the refractory cement by reducing abrasion and corrosion loss.

The convex first alumina particles may, in some embodiments, be substantially spherical. A perfect sphere has an aspect ratio of 1.0. The substantially spherical first alumina particles may have an aspect ratio of between 0.8 and 1.2. In some embodiments, the substantially spherical first alumina particles may have an aspect ratio of between 0.85 and 1.15. In some embodiments, the spherical first alumina particles may have an aspect ratio of between 0.9 and 1.1. In some embodiments, the spherical first alumina particles may have an aspect ratio of between 0.95 and 1.05. A substantially spherical particle is a convex particle.

The convex first alumina particles of the present invention, in some embodiments, may be most useful within a specific particle size range. In some embodiments, the first alumina particles may have a mean particle size (d₅₀) of between 0.1 and 5 mm. In some embodiments, the first alumina particles may have a mean particle size (d₅₀) of between 0.2 and 4 mm. In some embodiments, the first alumina particles may have a mean particle size (d₅₀) of between 0.4 and 2.5 mm. In some embodiments, the first alumina particles may have a mean particle size (d₅₀) of between 1.0 and 2.5 mm. In some embodiments, the first alumina particles may have a mean particle size (d₅₀) of between 1.5 and 2.5 mm. In some embodiments, the first alumina particles may be substantially monodisperse in particle size, having a d₉₀ dimension of less than 5 mm. In some embodiments, the first alumina particles may be between a mesh size of 8-12. The preferred mean particle sizes of the first alumina have been found to reduce frictional resistance at the contact surfaces between the refractory cement body and the fluid being handled, as well as to enhance bulk strength properties of the refractory cement body.

The convex first alumina particles of the present invention, in some embodiments, may be most useful within a specific concentration range of the refractory material-forming compositions, as well as within a specific concentration range of the total alumina particles in the compositions. In some embodiments, the first alumina particles comprise between 25-50 wt. % of the total alumina particles in the composition. In some embodiments, the first alumina particles comprise between 25-45 wt. % of the total alumina particles in the composition. In some embodiments, the first alumina particles comprise between 25-40 wt. % of the total alumina particles in the composition. In some embodiments, the first alumina particles comprise between 25-35 wt. % of the total alumina particles in the composition.

The convex first alumina particles of the present invention, in some embodiments, may comprise α-aluminum, which is aluminum metal in its highest oxidative state where no more oxidative reactions are possible and the chemical and physical stability of the material is the maximum achievable. In the lattice of α-alumina, each aluminum cations (Al₃⁺) is surrounded by oxygen anions (O₂⁻) forming two regular triangles on both sides, twisted by 180° and lying on parallel planes. This arrangement creates a hard surface that is particularly useful as an abrasion-resistant aggregate in the refractory-cement materials of the present invention. In some embodiments, the first alumina particles are sintered at temperatures exceeding 1200° C.

The alumina particles of the refractory cement-forming compositions of the present invention preferably include a second particulate alumina species. The second particulate alumina “species” refers to a type of class of alumina particles and may be referred to herein as the second particulate alumina. The first particulate alumina is different from the second particulate alumina, as described below. The particles of the second particulate alumina may have a spherical or non-spherical shape. In some embodiments, the second particulate alumina may have a non-spherical outer surface. In some embodiments, the second particulate alumina may have irregular outer surfaces. For the purposes hereof, the term “irregular” may mean lacking symmetry.

In some embodiments, the second alumina particles may be employed at least in part as a reactive alumina in the refractory cement. The reactive alumina of the second alumina particles are specifically configured to easily react and sinter with other constituents in the composition, at least in part to for mullite compounds with available silica. Typically, a reactive alumina is a fully ground calcinated alumina of which a substantial portion, such as between 20-90 vol. %, is of primary crystals. The reactive second alumina particles may have a monomodal particle size distribution, with one peak of population density around a particular particle size. In other embodiments, the reactive second alumina particles may have a multimodal particle size distribution.

The second alumina particles of the present invention, in some embodiments, may be most useful within a specific particle size range. In some embodiments, the second alumina particles may have a mean particle size (d₅₀) of between 0.1 and 5 μm. In some embodiments, the second alumina particles may have a mean particle size (d₅₀) of between 0.1 and 2.5 μm. In some embodiments, the second alumina particles may have a mean particle size (d₅₀) of between 0.5 and 2.5 μm. In some embodiments, the second alumina particles may have a mean particle size of between 0.5 and 1.5 μm. The second alumina particles may be substantially monomodal or monodisperse (99.4%). The preferred mean particle sizes of the second alumina have been found to enhance the reactability of the alumina with the silica to form a desired crystal phase for the refractory cement body with low water demand.

The second alumina particles of the present invention, in some embodiments, may be most useful within a specific concentration range of the refractory material-forming compositions, as well as within a specific concentration range of the total alumina particles in the compositions. In some embodiments, the second alumina particles comprise between 10-30 wt. % of the total alumina particles in the composition. In some embodiments, the second alumina particles comprise between 10-20 wt. % of the total alumina particles in the composition. In some embodiments, the second alumina particles comprise between 10-15 wt. % of the total alumina particles in the composition.

The second alumina particles of the present invention, in some embodiments, may comprise α-aluminum. In some embodiments, the second alumina particles are sintered at temperatures exceeding 1200° C.

The alumina particles of the refractory cement-forming compositions of the present invention may include a third particulate alumina species. The third particulate alumina “species” refers to a type or class of alumina particles and may be referred to herein as the third particulate alumina. The first particulate alumina and the second particulate alumina are different from the third particulate alumina, as described below. The particles of the third particulate alumina may have a spherical or non-spherical shape. In some embodiments, the third particulate alumina may have a non-spherical outer surface. In some embodiments, the third particulate alumina may have irregular outer surfaces.

In some embodiments, the third alumina particles may be provided as a tabular alumina, which is a fully shrunk coarse crystalline alumina that have been converted to its corundum form. Composed of tablet-like crystals, tabular alumina has high heat capacity and exceptional strength and volume stability at high temperatures. Tabular alumina may be produced by sintering caclinated alumina at temperatures exceeding 1650° C. The third alumina particles may have a monomodal particle size distribution, with one peak of population density around a particular particle size. In other embodiments, the third alumina particles may have a multimodal particle size distribution.

The third alumina particles of the present invention, in some embodiments, may be most useful within a specific particle size range. In some embodiments, the third alumina particles may have a mean particle size (d₅₀) of between 0.01 and 0.5 mm. In some embodiments, the third alumina particles may have a mean particle size (d₅₀) of between 0.01 and 0.1 mm. In some embodiments, the third alumina particles may have a mean particle size (d₅₀) of between 0.02 and 0.08 mm. The third alumina particles may be substantially monomodal or monodisperse. The preferred mean particle sizes of the third alumina have been found to enhance the crystal phase formation to a high-strength form.

The third alumina particles of the present invention, in some embodiments, may be most useful within a specific concentration range of the refractory material-forming compositions, as well as within a specific concentration range of the total alumina particles in the compositions. In some embodiments, the third alumina particles comprise between 20-50 wt. % of the total alumina particles in the composition. In some embodiments, the third alumina particles comprise between 25-45 wt. % of the total alumina particles in the composition. In some embodiments, the third alumina particles comprise between 30-45 wt. % of the total alumina particles in the composition.

The third alumina particles of the present invention, in some embodiments, may comprise α-aluminum. In some embodiments, the third alumina particles are sintered at temperatures exceeding 1650° C.

In addition to the α-alumina particles described above, the refractory material-forming compositions of the present invention may further include a ρ-alumina species, which is a class or type of alumina that is hydratable to hydrates and trihydrates in the presence of water. The hydratable ρ-alumina may be employed at least in part as a cement binder in the present refractory compositions. The ρ-alumina may be an amorphous alumina that is highly reactive in contact with water, forming strong hydraulic bonds. When used in the castable refractory compositions of the present invention, the ρ-alumina may accelerate the cement setting and improve overall rheology for castable performance. Example hydratable ρ-alumina materials include pseudo-boehmite and bayerite.

The ρ-alumina particles of the present invention, in some embodiments, may be most useful within a specific particle size range. In some embodiments, the ρ-alumina particles may have a mean particle size (d₅₀) of between 1 and 100 μm. In some embodiments, the ρ-alumina particles may have a mean particle size (d₅₀) of between 1 and 25 μm. In some embodiments, the ρ-alumina particles may have a mean particle size (d₅₀) of between 1 and 10 μm. In some embodiments, the ρ-alumina particles may have a substantially monodisperse particle size distribution, having a d₉₀ dimension of less than 50 μm.

The ρ-alumina particles of the present invention, in some embodiments, may be most useful within a specific concentration range of the refractory material-forming compositions, as well as within a specific concentration range of the total alumina particles in the compositions. In some embodiments, the ρ-alumina particles comprise between 10-25 wt. % of the total alumina particles in the composition. In some embodiments, the ρ-alumina particles comprise between 10-20 wt. % of the total alumina particles in the composition. In some embodiments, the ρ-alumina particles comprise between 10-15 wt. % of the total alumina particles in the composition.

### Silica

In embodiments of the present invention, compositions for forming a refractory cement include between 5-25 wt. % silica. In some embodiments, compositions for forming a refractory cement include between 10-20 wt. % silica. In some embodiments, compositions for forming a refractory cement include between 10-15 wt. % silica.

The silica utilized in compositions of the present invention may preferably be in particulate form. The silica particles may be heterogeneous or homogeneous in particle size and shape. In some embodiments, the heterogeneity may be limited to the presence of different groups of silica particles, wherein one or more groups of silica particles may exhibit monodispersity in one or both of particle size and shape.

The silica particles of the present invention, in some embodiments, may be most useful within a specific particle size range. In some embodiments, the silica particles may have a mean particle size (d₅₀) of less than 20 nm. The small particle size of the silica particles may be preferred in order to effectively disperse the silica throughout the mixed refractory cement-forming composition, and to thereby more completely react with the available alumina. In some embodiments, the silica particles may be supplied in an aqueous suspension. The small particle size of the silica particles may also be useful in avoiding settling in the aqueous suspension. The silica particles in this embodiment may be considered “colloidal” silica, which are suspensions of fine amorphous, nonporous, and typically spherical and/or oblong silica particles in a liquid phase. While treated or coated silica may be useful it is preferred to use silica having no treatment or coating on the surface.

### Water

The castable refractory composition sets upon addition of an appropriate amount of casting water. The appropriate amount of water will vary depending on the castable refractory composition and its intended use. In some embodiments, casting water may be sourced from the aqueous silica suspensions described above. In some embodiments, casting water may be sourced from other aqueous solutions added to the compositions of the present invention. In some embodiments, the compositions include between 5-20 wt. % water. In some embodiments, the compositions include between 5-15 wt. % water. In some embodiments, the compositions include between 5-12 wt. % water. In some embodiments, sufficient water for the reaction may be supplied in the aqueous silica suspension and other aqueous solutions so that no separate “added water” is necessary.

### Zirconia

Zirconium oxide (Zirconia) exhibits high resistance to slag corrosion and a very high melting point temperature (Tₘ>2700° C.). Inclusion of zirconia in the compositions of the present invention significantly enhances thermo-mechanical properties, corrosion resistance, and abrasion resistance in the refractory materials. Incorporating zirconia in the mullite crystal phase demonstrates improved physical properties of the refractory materials. However, it has been found that the concentration of zirconia must be within a specific range to achieve the enhanced properties. In some embodiments, the refractory materials of the present invention include up to 5 wt. % of zirconia. In some embodiments, the refractory materials of the present invention include between 1-5 wt. % of zirconia.

Zirconia (ZrO₂), Alumina (Al₂O₃), and Silica (SiO₂) are the primary oxides in the castable compositions of the present invention. Such oxides combine to form alumina-zirconia-silica (AZS) refractory materials. The alumina and silica combine to form a mullite, and mullite combines with zirconia to form an AZS refractory. Conventional AZS refractory materials typically contain between 43-50 wt. % Al₂O₃, 33-42 wt. % ZrO₂, and 13-20 wt. % SiO₂. The specific crystal phase of Zr formed at refractory cure temperatures between 1090-1650° C. is tetragonal t-ZrO₂.

Applicants have determined that zirconia may be obtained in the refractory materials of the present invention through the use of a zirconium component such as zirconium silicate. The zirconium silicate reacts in the system to become zirconia, and ultimately reacts with the mullite to form an AZS refractory material, but with low amounts of zirconia, such as less than 10 wt. %, and in some embodiments, between 1-5 wt. % zirconia. However, to account for incomplete reaction of the zirconium silicate component, it is contemplated that a higher concentration of zirconium silicate must be used in the compositions than simply using zirconium oxide. Thus, for a given target concentration of zirconia in the composition, zirconium silicate must be added in an amount of between 1.5 and 2 times the target zirconia concentration. In some embodiments, the refractory material-forming compositions include up to 10 wt. % zirconium silicate. In some embodiments, the refractory material-forming compositions include up to 5 wt. % zirconium silicate. In some embodiments the refractory material-forming compositions include between 1-5 wt. % zirconium silicate. In some embodiments the compositions contain no Zirconia (ZrO₂) before curing. In this embodiment, zirconia (ZrO₂) will be present in the cured or cast object made from the composition by reaction of the zirconium silicate during curing.

### Dispersing Agent

The compositions of the present invention may further include one or more additives, whether in solid form, liquid form, solution form, or otherwise, to enhance the properties of the castable composition and/or the final refractory material. In some embodiments a dispersing agent may be added to disperse components of the composition in the water, or to adjust the setting time or working time of the castable composition once mixed with water. Example dispersing agents include polycarboxylic acid, polyacrylates, polyglycols, polyglycolethers, polymelamines, polynaphthalenes, sodium phosphate, sodium aluminate, boric acid, calcium silicate, and mixtures thereof. In some embodiments, the compositions of the present invention may include between 0.01 and 2 wt. % of the dispersing agent. In some embodiments, the compositions of the present invention may include between 0.05 and 1 wt. % of the dispersing agent. In some embodiments, the compositions of the present invention may include between 0.1 and 0.5 wt. % of the dispersing agent.

### Other Components

The compositions of the present invention may include other components as deemed necessary for the application. Example additional components include surfactants, suspension stabilizers, anti-corrosion agents, stabilizers, and reinforcement members. It is further contemplated that the compositions may include small or trace amounts (<1 wt. %) of materials that are not considered to be important to the functionality of the refractory materials of the present invention. Examples of such materials include potassium oxide (K₂O), calcium oxide (CaO), titanium oxide (TiO₂), iron oxide (Fe₂O₃), barium oxide (BaO), sodium oxide (Na₂O), and magnesium oxide (MgO). In some embodiments, the compositions may be substantially free from one or more of such trace materials.

### Article

The present compositions are suitable for the manufacture of refractory articles, such as refractory cement articles for the handling of high temperature, corrosive, and/or abrasive fluids such as molten metal. In the iron smelting industry, such articles are referred to as refractory cement “runners”, which may be cast into forms that include a base portion between upstanding walls to define a channel along which the fluid may be conveyed along a pathway from a source to a mold. Naturally, the present compositions are also suitable to manufacture refractory brick or linings useful to insulate boilers, burners, etc.

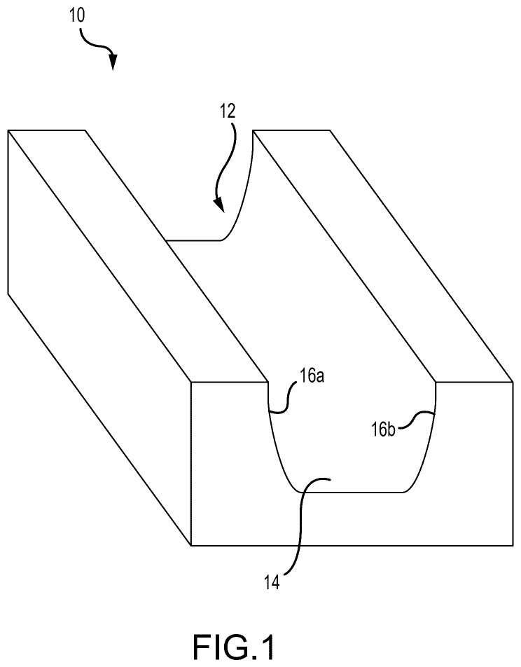

An embodiment of an article 10 formed from the refractory compositions of the present invention is illustrated in FIG. 1, including a channel 12 with a base portion 14 between first and second upstanding walls 16a, 16b.

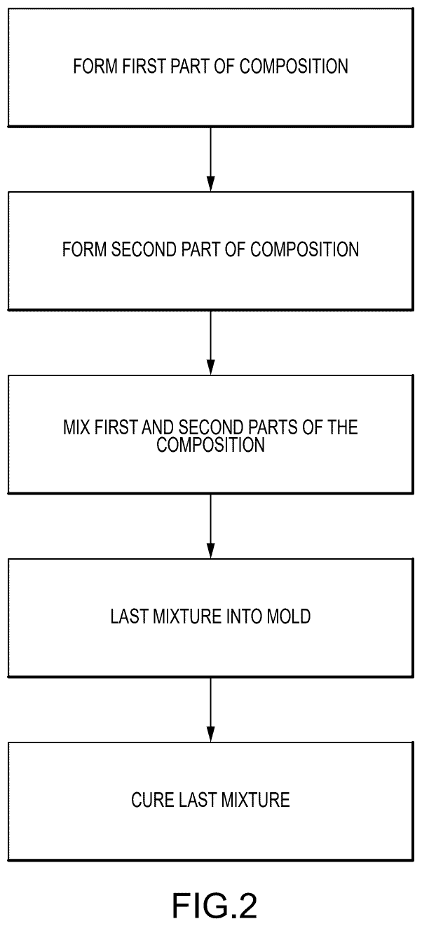

The refractory cement for forming article 10 may be produced as set forth in the flow diagram of FIG. 2. A first part of a composition is formed having 65-85 wt % alumina particles with an α-alumina component and a ρ-alumina component. The α-alumina component may include a heterogeneous particle shape distribution including a first particulate alumina of substantially spherical particles having a mean particle size (d₅₀) of between 0.1 and 5 mm. In some embodiments, the first part of the composition may further include a second particulate alumina of particles having a mean particle size (d₅₀) of between 0.1 and 5 μm, and a third particulate alumina of particles having a mean particle size (d₅₀) of between 0.01 and 0.5 mm. The ρ-alumina component may have a mean particle size (d₅₀) of between 1 and 100 μm.

A second, separate part of the composition is formed having water. At least one of the first and second parts of the composition includes silica in an amount of between 5-25 wt. % of the total composition, and optionally zirconium silicate in an amount of between 1-10 wt. % of the total composition. In some embodiments, the second part of the composition includes a dispersion of colloidal silica in water, wherein the suspending water may be used in the hydration of the ρ-alumina. The colloidal silica may have a mean particle size (d₅₀) of less than 20 nm.

In some embodiments, for every 100 g of sample, 81 grams of the first part was mixed with 19 grams of the second part under low-shear mixing in a cement mixer to form a thick paste. The slurry mixture may be cast into variously-shaped molds and cured in a high-temperature oven at maximum temperatures of either 1090° C. or 1650° C. The cured forms may be permitted to cool to room temperature under ambient conditions.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Comparative Example (A)

Bricks measuring 4.5″×4.5″×1″ were prepared from Hi Cast G refractory material from Alsey Refractories Co. of Alsey, IL, according to the manufacturer's instructions.

Chemical analysis was performed on the material, with the following results:

TABLE 1

| Material | wt. % |
|---|---|
| Alumina (Al₂O₃) | 88 |
| Silica (SiO₂) | 8 |
| Titanium dioxide (TiO₂) | <2.5 |
| Iron Oxide (Fe₂O₃) | <1.5 |
| Lime (CaO) | <1.0 |
| Magnesia (MgO) | <0.1 |
| Alkalies (Na₂O + K₂O) | <0.1 |

### WORKING EXAMPLES

Bricks measuring 4.5″×4.5″×1.0″ were prepared for abrasion test comparison with Comparative example A, and cube bricks measuring 2″×2″×2″ were prepared for thermal cycling and cold crush testing. Parts A and B were mixed in a cement mixer for 15 minutes to form a thick paste and then cast into molds and then vibrated with a cement vibrator for 3 minutes. The samples were then covered with moist towels and wrapped in a polyethylene bag and left at room temperature (21-25° C.) for 48 hours. The samples were then removed from the molds and dried in an oven at 100° C. for 10 hours. The samples were then placed in a high-temperature oven and heated gradually at 1.5° C./min to 400° C., where the temperature was held steady for 2 hours. The oven temperature was then increased gradually at 1.5° C./min up to either 1090° C. or 1650° C., depending upon the final cure temperature. Samples cured at a final cure temperature of 1090° C. are denoted by “A”, and samples cured at a final cure temperature of 1650° C. are denoted by “B” The final cure temperature was held steady for 4 hours. Thereafter, the oven was turned off, and the samples were left to cool in the oven to room temperature.

### Example 1

| Component | Wt. % | Description |
|---|---|---|
| Part A | | |
| Tabular α-alumina | 35.8 | D₅₀ = 0.045 mm |
| Spherical α-alumina | 25 | D₅₀ = 2.0 mm |
| Reactive α-alumina | 10 | D₅₀ = 1.2 μm |
| Hydratable ρ-alumina | 10 | D₅₀ = 4.0 μm |
| Polycarboxylic Acid | 0.2 | Dolopix FF 26 |
| Zirconium Silicate | 0 | |
| Part B | | |
| Colloidal Silica suspended in | 19 | 40 wt. % silica nanoparticles |
| water | | (<20 nm); 60 wt. % water |

### Example 2

| Component | Wt. % | Description |
|---|---|---|
| Part A | | |
| Tabular α-alumina | 34.8 | D₅₀ = 0.045 mm |
| Spherical α-alumina | 25 | D₅₀ = 2.0 mm |
| Reactive α-alumina | 10 | D₅₀ = 1.2 μm |
| Hydratable ρ-alumina | 10 | D₅₀ = 4.0 μm |
| Polycarboxylic Acid | 0.2 | Dolopix FF 26 |
| Zirconium Silicate | 1 | |
| Part B | | |
| Colloidal Silica suspended in | 19 | 40 wt. % silica nanoparticles |
| water | | (<20 nm); 60 wt. % water |

### Example 3

| Component | Wt.% | Description |
|---|---|---|
| Part A | | |
| Tabular α-alumina | 33.3 | D₅₀ = 0.045 mm |
| Spherical α-alumina | 25 | D₅₀ = 2.0 mm |
| Reactive α-alumina | 10 | D₅₀ = 1.2 μm |
| Hydratable ρ-alumina | 10 | D₅₀ = 4.0 μm |
| Polycarboxylic Acid | 0.2 | Dolopix FF 26 |
| Zirconium Silicate | 2.5 | |
| Part B | | |
| Colloidal Silica suspended in | 19 | 40 wt. % silica nanoparticles |
| water | | (<20 nm); 60 wt. % water |

### Example 4

| Component | Wt. % | Description |
|---|---|---|
| Part A | | |
| Tabular α-alumina | 30.8 | D₅₀ = 0.045 mm |
| Spherical α-alumina | 25 | D₅₀ = 2.0 mm |
| Reactive α-alumina | 10 | D₅₀ = 1.2 μm |
| Hydratable ρ-alumina | 10 | D₅₀ = 4.0 μm |
| Polycarboxylic Acid | 0.2 | Dolopix FF 26 |
| Zirconium Silicate | 5 | |
| Part B | | |
| Colloidal Silica suspended in | 19 | 40 wt. % silica nanoparticles |
| water | | (<20 nm); 60 wt. % water |

### Example 5

| Component | Wt. % | Description |
|---|---|---|
| Part A | | |
| Tabular α-alumina | 25.8 | D₅₀ = 0.045 mm |
| Spherical α-alumina | 25 | D₅₀ = 2.0 mm |
| Reactive α-alumina | 10 | D₅₀ = 1.2 μm |
| Hydratable ρ-alumina | 10 | D₅₀ = 4.0 μm |
| Polycarboxylic Acid | 0.2 | Dolopix FF 26 |
| Zirconium Silicate | 10 | |
| Part B | | |
| Colloidal Silica suspended in | 19 | 40 wt. % silica nanoparticles |
| water | | (<20 nm); 60 wt. % water |

### Abrasion Resistance Testing

Prepared bricks of 4.5″×4.5″×1″ for each of Examples 1A, 1B, 4A, 4B, 5A, and 5B were tested for abrasion resistance in accordance with ASTM C-704 by placing the sample in an abrasion blast chamber, and impacting one surface of the sample with 36 grit silicon carbide media using an air pressure of 52 psi for 7 minutes. The following Table 2 shows the mass loss (%) for each sample, with a target loss of <6%.

TABLE 2

| Example | Abrasion Loss (%) |
|---|---|
| 1A | 4.6 |
| 1B | 3.3 |
| 4A | 4.5 |
| 4B | 5.1 |
| 5A | 5.1 |
| 5B | 9.9 |

The results demonstrate that samples with 0-5 wt. % zirconia (Examples 1 and 4) outperform samples with 10 wt. % zirconia (Example 5).

### Combination Thermal Cycle/Abrasion Resistance Testing

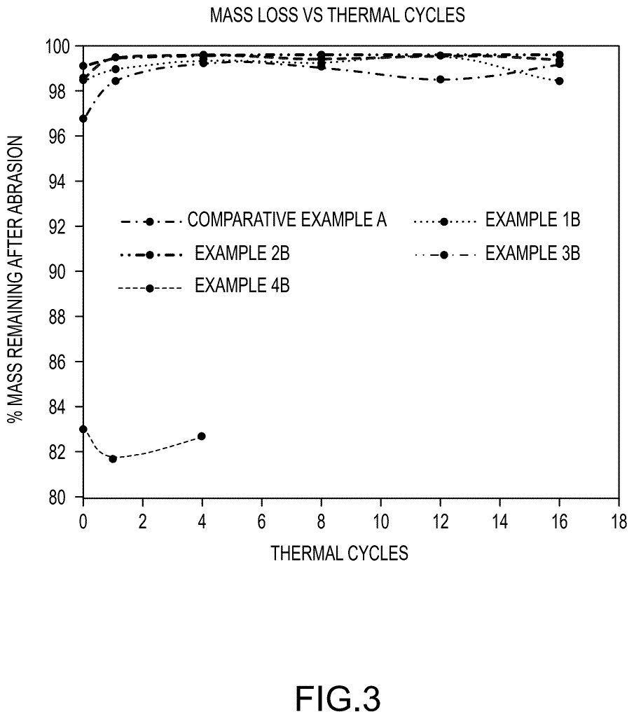

Further abrasion resistance testing was performed in combination with thermal cycling of 4.5″×4.5″×1″ bricks of Examples 1B-4B and Comparative Example A. Each thermal cycle for the combination abrasion testing included heating the brick at 1650° C. for 6 minutes, followed by cooling at ambient room conditions for 10 minutes. After each thermal cycle, the brick was exposed to 20 Grit silicon carbide media using an air pressure of 52 psi for 1 minute. The mass of each brick was measured before and after each combination cycle to calculate mass loss (%). FIG. 3 shows a chart of the % mass remaining after each thermal cycle.

The testing demonstrated that incorporation of zirconia into the composition improved the abrasion resistance in comparison to the Comparative Example A, which lost about 18% of its mass after a single thermal cycle, and completely disintegrated after four thermal cycles. By contrast, the Example compositions lost less than 4% of their initial mass over 16 thermal cycles.

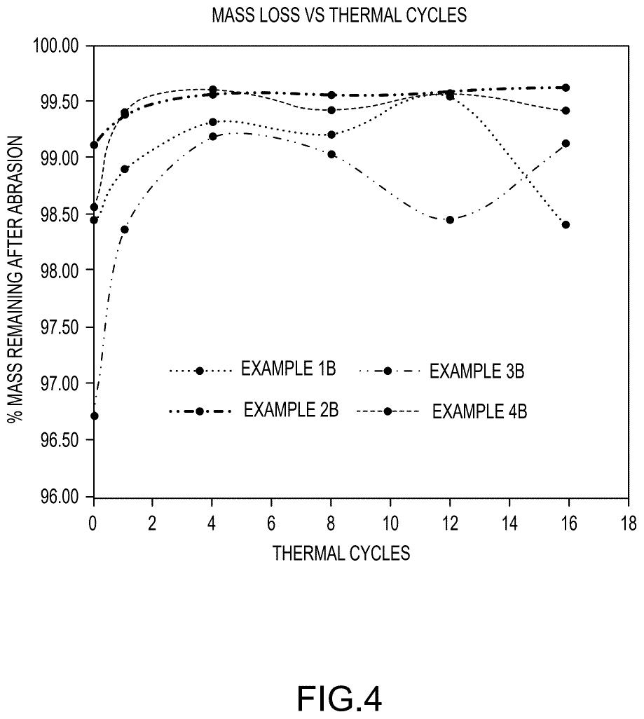

FIG. 4 is an enlarged view of only the bricks from Examples 1B, 2B, 3B, and 4B. The 2.5% and 5% zirconia examples (Examples 3B and 4B) demonstrated the highest abrasion resistance over 16 thermal cycles.

### Cold Crush Strength Testing

Prepared bricks of 2″×2″×2″ for each of Examples 1A, 1B, 4A, 4B, 5A, and 5B were tested for cold crush strength in accordance with ASTM C133 by placing the brick between two adjacent platens of a compression testing apparatus. One platen is moved toward the other platen to impose a compression force on the sample. Compression force is increasingly applied until the sample is crushed, and the accompanying compression force is recorded. The following Table 3 shows the recorded cold crush strength for each of the above Examples, with respective curing temperatures of 1090° C. and 1650° C., with a target cold crush strength of greater than 45 MPa.

TABLE 3

| Example | Cold Crush Strength (MPa) |
|---|---|
| 1A | 55.3 |
| 1B | 50.7 |
| 4A | 50.4 |
| 4B | 60.7 |
| 5A | 24.8 |
| 5B | 40.3 |

The testing demonstrated that the samples with 10 wt % zirconia (Examples 5A and 5B) failed to reach the desired cold crush strength threshold of greater than 45 MPa.

### Thermal Shock/Cold Crush Strength Testing

Further cold crush strength testing was performed in combination with thermal shocks on prepared 2″×2″×2″ bricks of Examples 1A, 4A, and 5A. Each thermal shock includes placing a room temperature sample in an oven held at a temperature of 950° C. for 5.5 hours. The sample is then removed from the oven and quenched by submerging in a water bath having an initial temperature of 10.5-12.8° C. for 3 minutes. The sample is then removed from the water bath and placed in an oven at 110° C. for 30 minutes to dry the sample. The thermal shock was repeated 30 times prior to cold crush strength testing according to ASTM C-133.

The following Table 4 shows the recorded cold crush strength for each of the Examples, both before and after the 30 cycles of thermal shock treatment.

TABLE 4

| | Cold Crush Strength/ | Cold Crush Strength/After |
|---|---|---|
| | Before Thermal Shock | Thermal Shock Testing |
| Example | Testing (MPa) | (MPa) |
| 1A | 34 | 22.8 |
| 4A | 49 | 39 |
| 5A | 48.6 | 0 |

The testing demonstrated that the sample with 10 wt. % zirconia failed the cold crush test after thermal shock testing.

1. A composition for forming a refractory cement, the composition comprising:
65-85 wt. % alumina particles having a heterogeneous particle shape distribution, including a first particulate alumina of particles with a convex outer surface shape and a median particle size (d₅₀) of between 0.1 and 5 mm, and a second particulate alumina of particles with an irregular outer surface shape, the first alumina comprising between 25-50 wt. % of the total alumina particles in the composition;
5-25 wt. % silica; and
up to 10 wt. % zirconium silicate.

2. The composition as in claim 1, including 5-20 wt. % water and 1-5 wt. % zirconium silicate.

3. The composition as in claim 2, including a first part that is mixable with a second part to form the refractory cement, the first part including the alumina particles, and the second part including the water.

4. The composition as in claim 3 wherein the second part further includes the silica.

5. The composition as in claim 1 wherein the alumina particles include an α-alumina component and a ρ-alumina component, the α-alumina component including the first particulate alumina.

6. The composition as in claim 5 wherein the ρ-alumina component has a mean particle size (d₅₀) of between 1-100 μm and wherein the ρ-alumina component comprises between 10-25 wt. % of the total alumina particles.

7. The composition as in claim 5 wherein the α-alumina component includes the second particulate alumina having a mean particle size (d₅₀) of between 0.1 and 5 μm, and a third particulate alumina having a mean particle size (d₅₀) of between 0.01 and 0.5 mm.

8. The composition as in claim 1 wherein the silica comprises particles having a mean particle size (d₅₀) of less than 20 nm.

9. The composition as in claim 1 wherein the first alumina particles are substantially spherical, having an aspect ratio of between 0.8 and 1.2.

10. The composition as in claim 1, including a dispersing agent comprising a polycarboxylic acid.

11. A refractory cement, comprising:
65-85 wt. % alumina;
10-20 wt. % silica;
1-5 wt. % zirconium oxide,
wherein an aggregate portion of the refractory cement includes substantially spherical α-alumina particles having an aspect ratio of between 0.8 and 1.2.

12. The refractory cement as in claim 11, wherein the substantially spherical α-alumina particles have a median particle size (d₅₀) of between 0.1 and 2.5 mm, and the aggregate portion comprises between 25-45 wt. % of the refractory cement.

13. The refractory cement as in claim 12 wherein the substantially spherical α-alumina particles are substantially monodispersed in particle size, having a d₉₀ dimension of less than 5 mm.

14. An article formed from the refractory cement of claim 11.

15. The article of claim 14 being configured for conveying molten material, the article comprising a channel with a base portion between first and second upstanding walls.

16. A method for producing a refractory cement, the method comprising:
(a) forming a first part of a composition, the first part including 65-85 wt. % alumina particles having an α-alumina component and a ρ-alumina component, the α-alumina component including a heterogeneous particle shape distribution comprising a first particulate alumina of substantially spherical particles having a mean particle size (d₅₀) of between 0.1 and 5 mm;
(b) forming a second part of the composition including water, wherein at least one of the first and second parts includes zirconium silicate and silica, the zirconium silicate being present in an amount of between 1-10 wt. % of the composition, and the silica being present in an amount of between 5-25 wt. % of the composition;
(c) mixing the first and second parts; and
(d) curing the mixture of step (c) at a temperature of at least 1000° C.

17. The method as in claim 16 wherein the α-alumina component of the first part includes a second particulate alumina of particles having a mean particle size (d₅₀) of between 0.01 and 0.5 mm, and a third particulate alumina of particles having a mean particle size (d₅₀) of between 0.1 and 5 μm.

18. The method as in claim 17 wherein the particles of the second and third particulate alumina are irregular in shape.

19. The method as in claim 16 wherein the composition includes a dispersing agent comprising a polycarboxylic acid.

20. The method as in claim 16 wherein the silica is particulate in form with a mean particle size (d₅₀) of less than 20 nm.
